(19) United States
(12) Patent Application Publication
(10) Pub. No.: US 2020/0305408 A1
(43) Pub. Date: Oct. 1, 2020

(54) METHOD FOR A SPRAYING DEVICE

(71) Applicant: Robert Bosch GmbH, Stuttgart (DE)

(72) Inventors: Bernd Stuke, Leonberg (DE); Hans-Arndt Freudigmann, Tuebingen (DE); Helmut Schomburg, Deufringen (DE); Olaf Ohlhafer, Erligheim (DE); Steffen Sies, Rottenburg (DE)

(21) Appl. No.: 16/753,940

(22) PCT Filed: Oct. 16, 2018
(86) PCT No.: PCT/EP2018/078238

§ 371 Date: Apr. 6, 2020

(30) Foreign Application Priority Data
Nov. 10, 2017 (DE) 10 2017 220 008.1

(51) Int. Cl. A01M 7/00

(52) U.S. Cl. CPC A01M 7/0092; B05B 1/20; A01M 7/0042

(57) ABSTRACT

A method for detecting at least one spray liquid data set of a spray liquid applied to an agricultural area using at least one spray nozzle unit of a spraying device. The method includes receiving a property signal, including a piece of property information of the spray liquid detected using a sensor unit of the spraying device in a through-flow area of the spray nozzle unit during an application operation of the spray liquid; receiving a position signal, including a piece of position information of the spray liquid, using a position unit, the position information representing a geographic position of the spray liquid during the application operation of the spray liquid; and storing the property information and/or a piece of spray liquid information of the applied spray liquid ascertained using the property information, together with the associated position information, using an information unit, for detecting the spray liquid data set.

### FIELD

The present invention relates to a method for detecting at least one spray liquid data set of a spray liquid applied to an agricultural area with the aid of at least one spray nozzle unit of a spraying device, as well as a spraying device of this type.

An information unit and a computer program are also the subject matter of provided in accordance with the present invention.

### BACKGROUND

In the field sprayers used today, the compounds are largely applied over a wide area. The plant protection application must be documented manually. The application rate of the plant protection agent for the entire field treated is viewed as constant.

Conventionally, flow meters at nozzles are used for monitoring the functionality of the nozzles.

### SUMMARY

An object of the present invention is to provided a method for detecting at least one spray liquid data set of a spray liquid applied to an agricultural area with the aid of at least one spray nozzle unit of a spraying device. An example method according to the present invention includes the steps:
receiving at least one property signal, including a piece of property information of the spray liquid, detected with the aid of a sensor unit of the spraying device in a through-flow area of the at least one spray nozzle unit during an application operation of the spray liquid;
receiving at least one position signal, including a piece of position information of the spray liquid, with the aid of a position unit, the position information representing a geographic position of the spray liquid during the application operation of the spray liquid; and
storing the property information and/or a piece of spray liquid information of the applied spray liquid ascertained using the property information, together with the associated position information, with the aid of an information unit for the purpose of detecting the spray liquid data set.

An object of the present invention is also to provide an information unit, which is configured to carry out all steps of the example method described above.

An object of the present invention is furthermore to provide a spraying device for applying a spray liquid with the aid of at least one spray nozzle unit, in particular for agricultural purposes. In accordance with an example embodiment of the present invention, the spraying device includes:
a sensor unit for detecting a piece of property information of the spray liquid in a through-flow area of the at least one spray nozzle unit during an application operation of the spray liquid;
a position unit for detecting a piece of position information of the spray liquid, the position information representing a geographic position of the spray liquid during the application operation of the spray liquid; and
an information unit described above for detecting a spray liquid data set, and/or a transmission unit for transmitting the detected property information together with the associated position information, and/or a piece of spray liquid information ascertained using the property information, together with the associated position information, to an information unit for the purpose of detecting a spray liquid data set with the aid of the information unit.

An object of the present invention is also to provide a computer program, which is configured to carry out all steps of the example method described above, as well as a machine-readable storage medium, including the computer program stored thereon.

An agricultural purpose may be understood within the scope of the present invention to be a purpose aimed at an economical cultivation of crops.

The example spraying device may be, in particular, part of an agricultural field sprayer or a plant protection device, or it may be designed as an agricultural field sprayer or a plant protection device. The spraying device may be suitable and/or situated on or at a mobile unit. The mobile unit may be designed as a farm vehicle and/or an aircraft and/or a trailer. In particular, the mobile unit may be an agricultural machine, for example a traction engine, a tractor or a (self-propelled or autonomous) field sprayer. The spraying device may be mounted on a hydraulic device of the agricultural machine. It is also possible that the spraying device is mounted on a loading platform of the agricultural machine. Alternatively, the spraying device may be hooked up to the agricultural machine.

The spraying liquid is preferably applied to a field. In the present case, an agricultural area or an area used for agricultural purposes may be understood to be a crop area for plants or a lot of such an area or crop area. The field may thus be a piece of agricultural crop land, a grassland or a pasture. The plants may be, for example, crops whose yield is used for agricultural purposes (for example as food, fodder or as an energy crop) as well as weeds or weed grasses. The plants may be part of the agricultural area.

The term “spray liquid” covers, within the scope of the present invention, the entire spray liquid as well as only one part or fraction, in particular a spatially limited part or fraction, of the spray liquid in the spraying device.

The spatially limited part or fraction of the spray liquid may be, for example, the part of the spray liquid situated in a spray nozzle unit.

The spray liquid applied or to be applied includes at least one active agent. The active agent may include a spray agent, i.e., a compound or plant protection agent, in particular a plant protection agent concentrate. The active agent may therefore include, for example, an herbicide, a fungicide or an insecticide (pesticide). The spray liquid may be a spray mixture. However, the active agent may also be a fertilizer, in particular a fertilizer concentrate. The active agent may therefore be a liquid fertilizer and/or a growth regulator. The active agent may be designed as a liquid or as a solid, for example in the form of granulated materials or as a pre-dissolved solid, for example in the form of pre-dissolved granulated materials.

The spray liquid applied or to be applied preferably also includes a liquid, in particular a carrier liquid, for diluting the active agent. Within the scope of the present invention, a carrier liquid may be understood to be a liquid which is designed to be mixed with active agent for the purpose of facilitating or improving the application or output of the active agent, for example the plant protection agent or the fertilizer. It is also possible that an active agent present as a solid or a granulated material is suspended in the carrier liquid. It is furthermore possible that an active agent which is insoluble in the carrier liquid is emulsified in the carrier liquid. The carrier liquid is preferably water.

The spray liquid may therefore be designed as: a liquid, a suspension, an emulsion, a solution or a combination thereof. The spray liquid is preferably designed as a plant protection agent, which is diluted with water, or as a fertilizer, which is diluted with water.

The spraying device preferably includes a spray liquid tank for accommodating the spray liquid and at least one spray nozzle unit for applying the spray liquid. The spray liquid may be guided or conducted from the spray liquid tank to the spray nozzle unit with the aid of a spray liquid line or multiple spray liquid lines. Within the scope of the present invention, a line or a spray liquid line may also be understood to be a section of the corresponding line or the spray liquid line. The line may be designed as a fluidic connecting line, for example in the form of a tube, hose, channel or a pipe.

The spray liquid may be filled into the spray liquid tank of the spraying device in ready-made mixed form. However, the spray liquid may also be mixed right in the spraying device. To mix the spray liquid, the spraying device may include a mixing unit situated upstream from the spray liquid tank (in the flow direction of the spray liquid), into which the liquid may be guided or conducted from a liquid tank of the spraying device, and the active agent may be guided or conducted from an active agent tank of the spraying device. A liquid delivery unit may be provided, which is designed to conduct or to deliver the liquid in a targeted or defined manner from the liquid tank to the mixing unit via a liquid line. An active agent delivery unit may furthermore be provided, which is designed to conduct or to deliver the active agent in a targeted or defined or dosed manner from the active agent tank to the mixing unit via an active agent line. The delivery units may include one or multiple dosing units or dosing components. The dosing units or dosing components may include one or multiple pumps or dosing pumps and valves. At least one of the delivery units may be designed to generate the spraying pressure at the spray nozzle unit, i.e., the pressure at which the spray liquid is applied.

A mixing unit within the scope of the present invention may be understood to be a unit which is designed to mix or blend together, preferably homogeneously, at least the liquid and the active agent to form the spray liquid. The mixing unit may include a mixing and/or stirring element to actively mix together the liquid and the active agent. The stirring element may be designed as an agitator blade or a propeller. The mixing unit may include a mixing tank having at least one inlet for the liquid and one inlet for the active agent. In other words, the liquid and the active agent may be guided directly into the mixing unit or the mixing tank separately, i.e., with the aid of separate lines. Alternatively, a shared inlet may be provided at the mixing unit in the form of a T piece, the active agent being initially supplied to the liquid or fed thereinto and subsequently guided into the mixing unit together with the liquid. The mixing unit or the mixing tank may include at least one outlet for the mixed or blended spray liquid, for example in a lower area. It is also possible that the mixing unit is designed as a static mixing unit or stationary mixer. However, the mixing unit may also be designed only as a T piece, so that a passive mixing takes place therein.

The mixing unit may also be integrated into the spray liquid tank. Accordingly, the spray liquid tank may be designed as a mixing tank of the mixing unit. The mixing and/or stirring element may be situated at or in the spray liquid tank to mix or blend the spray liquid.

However, the spray liquid tank may also be situated in the spray liquid line downstream from the mixing unit. In other words, the spray liquid tank may be situated behind or after the mixing unit in the flow direction of the spray liquid from the mixing unit in the direction of the spray nozzle unit. The spray liquid tank may thus be spatially situated in the spray liquid line between the mixing unit and the spray nozzle unit. The spray liquid tank may be designed as a buffer tank, so that the spray liquid may be initially guided or filled from the mixing unit into the buffer tank and then guided or conveyed or conducted to the spray nozzle unit as needed.

Moreover, the spraying device may include a spray liquid delivery unit, which is situated in the spray liquid line downstream from the spray liquid tank or buffer tank and/or integrated thereinto. The spray liquid delivery unit may then be designed to conduct the spray liquid from the spray liquid tank or the buffer tank to the spray nozzles or spray nozzle units under pressure or under a defined pressure. The spray liquid delivery unit may be designed, in particular, to generate a constant pressure, i.e., be designed as a constant pressure system, for the purpose of generating a constant or uniform spraying pressure at the spray nozzles or the spray nozzle units. Since the defined spraying pressure is generated by the spray liquid delivery unit, the delivery units may be very easily provided upstream from the buffer tank, i.e., the liquid delivery unit and the active agent delivery unit, since they must only perform the function of supplying the liquid or the active agent to the buffer tank.

If the spray nozzle delivery unit is integrated into the buffer tank, the buffer tank may be designed as a pressure accumulator, for example including media separation (spray liquid-air). The pressure regulation in the buffer tank may take place via a pneumatic pressure control valve, so that possible pressure fluctuations in the system may be reduced. However, the spray liquid delivery unit is preferably situated downstream from the spray liquid tank, whereby the buffer tank may be provided with a depressurized design. The buffer tank may be provided with a depressurized design, for example with the aid of a venting bore. The venting bore may include a venting valve. In other words, the buffer tank is fluidically connected to the surroundings or is connectable at a defined internal pressure, so that it has a depressurized design. Due to this measure, the liquid delivery unit and the active agent delivery unit advantageously no longer operate against the high system pressure but only against the ambient pressure (and the counter-pressure which sets in due to flow losses), so that the pressure requirements imposed on the corresponding pumps or dosing pumps may be further reduced. For example, the liquid delivery unit may include a simple flow pump or delivery pump, which has a pure in/out functionality. In connection with a volume flow meter, the necessary dosing volume flow of the active agent may be ascertained and the active agent dosing pump activated via the volume flow signal and the preset mixing ratio.

Alternatively, the liquid delivery unit may include a dosing pump having a fixed delivery ratio (without measuring the delivery rate). It is also possible that the liquid delivery unit includes a simple valve or proportional valve in connection with a volume flow meter and a constant pressure source in the liquid line. It is also possible that the liquid delivery unit includes a constant pressure source and a dosing orifice. Alternatively, to the dosing pump, the active agent delivery unit may include a simple delivery pump in connection with a volume flow meter (regulation). The active agent delivery unit may additionally include at least one dosing orifice. In addition, the buffer storage unit is designed to be very simple and essentially without static requirements, whereby the total costs may be further reduced.

The spray nozzle unit includes at least one spray nozzle in each case for applying the spray liquid, and at least one valve for controlling or regulating the applied spray liquid quantity. Accordingly, the spray nozzle unit is designed to be controllable or actuatable, i.e., it may be opened and closed. Each of the spray nozzle units may preferably be controlled separately. The valve may be situated in or integrated into the spray nozzle. However, the valve may also be connected ahead of the spray nozzle, i.e., upstream from the spray nozzle (in the flow direction of the spray liquid). However, the spray nozzle unit may also include multiple spray nozzles, each having a valve connected upstream. The spray nozzle unit may furthermore include multiple spray nozzles, having only one valve connected upstream from the spray nozzles, so that the spray liquid is applied with the aid of all spray nozzles of the spray nozzle unit when the valve is actuated. Accordingly, the spray nozzle unit may be designed as a partial width of a nozzle system. The spray nozzle unit may also include an end mixing unit, which is designed to mix the spray liquid with the liquid and/or the active agent and/or another active agent—which may be conducted or guided to the end mixing unit with the aid of corresponding lines. It is advantageous to provide a combination of the end mixing unit and the mixing unit described above, which would be designed in this case as a premixing unit, to obtain a two-stage mixing system.

The through-flow area of the spray nozzle unit, in which the property information of the spray liquid is detected, is an area through which spray liquid may flow. Accordingly, it is an area which comes into contact with the spray liquid, in particular during an application operation of the spray liquid. The through-flow area is preferably situated in at least one component, which is selected from the group including: a spray nozzle, a valve, a spray liquid line of the spray liquid unit. The through-flow area may include a section of an interior or the entire interior of the corresponding component. The through-flow area is preferably situated in or immediately before the spray nozzle(s).

The sensor unit may include a sensor element or a sensor or also multiple sensor elements or sensors. The sensor unit may be situated in the through-flow area. The sensor unit may be in direct contact with the spray liquid for the purpose of detecting the property information of the spray liquid. However, the sensor unit may also be situated outside the through-flow area. The sensor unit may be designed to contactlessly detect the property information of the spray liquid. The sensor unit may also be designed to detect a temperature of the spray liquid in the through-flow area in addition to the property information. The sensor unit may include a transmission unit. The transmission unit may be designed to transmit or send the property signal, including the detected values or measured values of the property information, wirelessly, for example via radio, WLAN, Bluetooth, etc., and/or in a hard-wired manner.

The property signal includes the detected property information or a detected value/measured value of the property information. The property information is detected during the application operation. The property information is preferably detected for the entire duration of the application operation. The property information may include a physical and/or chemical and/or material and/or substance-based property of the spray liquid. An active agent concentration in the spray liquid is preferably ascertainable using the detected property information or the detected value of the property information. In other words, an active agent concentration in the spray liquid may be (directly or indirectly) derived from the property information. In particular, the property information of the spray liquid and the active agent concentration in the spray liquid are essentially clearly dependent on each other. The property information of the spray liquid and the active agent concentration in the spray liquid may be linearly dependent on each other. The active agent concentration in the spray liquid may therefore be inferred with the aid of the detected property information or the detected value of the property information.

The detected property information is preferably selected from the group made up of: electrical property, in particular electrical conductivity or permittivity, optical property, in particular absorption property, emission property, fluorescence, sound velocity or combinations thereof. An active agent concentration in the spray liquid may be very easily ascertained hereby with the aid of computation methods known to those skilled in the art. The detected property information preferably includes an electrical conductivity.

For example, the electrical conductivity of a solution is thus a universal physical variable and indicates the ability of a substance to conduct electrical current. This conductivity is greatly dependent on the quantity of dissolved salts, which are either already present in the active agents or spraying agents, or which may be specifically added to the active agents by the manufacturers or the farmers. In addition to the conductivity, other physically measurable substance variables for determining the concentration of the active agent may also be used. The clouding of the solution (and thus the absorption coefficient for light) or the sound velocity (in particular, dependent on the density and compressibility of the medium) thus also changes together with the concentration of the active agent in water, due to the fraction of undissolved particles in the solution. Likewise, it is possible to infer the concentration of the active agent, for example with the aid of fluorescence measurements. In this case, a type of tracer (e.g., dye) may also be added to the active agents.

The property information further preferably includes a volume flow of the spray liquid. Here, the sensor units include a flow sensor or a volume flow sensor.

A value of the spray liquid information may be ascertained using a value of the property information. Accordingly, the spray liquid information is a variable which is (directly or indirectly) derivable from the property information. The ascertained spray liquid information is preferably an active agent concentration in the applied spray liquid and/or a quantity of the applied spray liquid. The position signal includes a piece of position information of the spray liquid, the position information representing a geographic position of the spray liquid during the application operation of the spray liquid. In other words, the position information includes a geographic position of the spray liquid, at which the spray liquid was applied. The position information is preferably detected during the application operation, in particular for the entire duration of the application operation. The position information preferably includes a geographic position, in particular a GPS position, of the spraying device and/or the particular spray nozzle unit, with the aid of which the spray liquid was applied. The position information is detected with the aid of a position unit. The position unit is preferably a GPS unit. The GPS unit may be a GPS unit which is present in or integrated into a vehicle at which the spraying device is situated.

The property information and the position information of the spray liquid are preferably detected for the entire duration of the application operation.

In the receiving step, a large number of property signals are preferably received. Here, each property signal includes one piece of property information of the spray liquid in one through-flow area of the spray nozzle units, in particular each of the spray nozzle units. The property information is detected in each case during an application operation with the aid of a sensor unit of the spraying device. Accordingly, a large number of position signals, each including one piece of position information of the spray liquid, are correspondingly received in the receiving step for the purpose of storing the large number of pieces of property information and/or ascertained spray liquid information of the spray liquid in the storing step, in each case together with the associated position information, and to thereby detect a large number of spray liquid data sets.

The steps of receiving the property signal and receiving the position signal may be carried out with the aid of an information unit. The ascertainment or calculation of the values of the spray liquid information, in particular the active agent concentration in the applied spray liquid and the quantity of the applied spray liquid, may also be carried out with the aid of the information unit and computation methods known to those skilled in the art.

The information unit is further configured to store the property information and/or the ascertained spray liquid information of the applied spray liquid, together with the associated position information, in a memory unit for the purpose of detecting the spray liquid data set. A spray liquid data set may be understood to be a data set, in which the plant information, including a piece of property information and/or a piece of spray liquid information of the applied spray liquid ascertained using the property information, is contained, together with the associated position information. The spray liquid data set is designed, in particular, to be displayed on the display unit. The display unit may be a display, a smartphone or another arbitrary terminal, such as a tablet or a PC.

An information unit may be understood in the present case to be an electrical device, which is configured to receive and process sensor signals, information and data and to store them or the processed information and data in a memory unit. For this purpose, the information unit may include at least one processing unit for processing the property signals or property information and for ascertaining the spray liquid information. The processing unit may be, for example, a signal processor, a microcontroller or the like. The information unit also includes at least one memory unit for storing the property information and/or the spray liquid information, in each case together with the associated position information, or it is connected to a memory unit for this purpose. The memory unit may be, for example, a cloud server, a flash memory, an EPROM or a magnetic memory unit. The information unit may also include at least one communication interface for reading in the property signals and the position signals. The communication interface may be designed to read in and possibly output the signals wirelessly, for example via radio, WLAN, Bluetooth, etc., and/or in a hard-wired manner. The communication interface may be provided with a hardware and/or software design. In the case of a hardware design, the interface may be, for example, part of a so-called system ASIC, which includes a wide range of functions of the information unit. It is, however, also possible that the interface includes independent, integrated circuits or are at least partially made up of discrete components. In the case of a software design, the interface may be a software module which is present, for example, on a microcontroller in addition to other software modules.

The information unit may advantageously be designed to create an application map, using the detected spray liquid data sets, in particular including values of spray liquid information.

The information unit may be part of the spraying device. Accordingly, the information unit may be situated at the spraying device. However, the information unit may also be an external device, to which the input signals from the spraying device are transmitted via a transmission unit.

Due to the example method according to the present invention and the example spraying device according to the present invention, it is now possible to easily and cost-effectively carry out an automated, property-specific and spatially resolved documentation and mapping of the spray liquid actually applied or expended on an agricultural area. This is achieved, in particular, in that at least one piece of property information, together with an associated piece of position information of the actually applied spray liquid, is detected and stored for the purpose of detecting a spray liquid data set. For example, due to a spatially resolved documentation of detected active agent concentrations of the applied spray liquid as well as detected applied spray liquid quantities, in particular more precise details of soil and plant contamination may be made with regard to the actually applied spray liquid, and corresponding spatially resolved maps of application rates of individual active agents for spraying devices may be prepared. The method and the spraying device are particularly advantageous in so-called spot applications, in which the same spray liquid is not always applied broadly but instead is applied in a targeted manner, possibly additionally with varying compositions and/or different quantities of the spray liquid.

It is furthermore advantageous if the value of the property information and/or the spray liquid information is ascertained using the property information of a carrier liquid of the spray liquid detected with the aid of another sensor unit. Due to this measure, the method may be carried out even more precisely, since the actual property information of the carrier liquid is detected as a “base value” without the active agent and is taken into account or calculated during the ascertainment of the aforementioned values.

It is also advantageous if the value of the property information and/or the spray liquid information is ascertained using a temperature of the spray liquid and/or the carrier liquid detected with the aid of the sensor unit and/or the additional sensor unit. It is advantageous, in particular, if the temperature is detected at the location at which the corresponding property information is also detected. Since the temperature generally has an influence on the property information (conductivity, density, etc.), the method may be carried out even more precisely by taking this factor into account during the detection and ascertainment of the property information and/or the active agent concentration.

To detect the property information with the aid of absorption, the pressure may also be measured similarly to the temperature, so that the sensor unit may alternatively or additionally include a pressure sensor for this purpose.

It is moreover advantageous if the property information and the position information of the spray liquid are detected during a treatment operation, in particular for the entire duration of a treatment operation, in which the entire agricultural area to be treated is essentially treated. In other words, the property information and the position information of the spray liquid is detected from the beginning to the end of the treatment of the agricultural area, so that the entire travel path as well as the property information of the spray liquid applied on this travel path may be detected simultaneously. A complete application map may be very easily created thereby.

### BRIEF DESCRIPTION OF THE DRAWINGS

The present invention is explained below in greater detail, as an example, on the basis of the figures.

FIG. 1 shows a schematic representation of one exemplary embodiment of the spraying device.

FIG. 2 shows a schematic representation of the information unit.

FIG. 3 shows a flowchart of a method for detecting a spray liquid data set.

### DETAILED DESCRIPTION OF EXAMPLE EMBODIMENTS

In the following description of preferred exemplary embodiments of the present invention, the elements which are illustrated in the various figures and appear to be similar are identified with identical or similar reference numerals; a repetitive description of these elements is dispensed with.

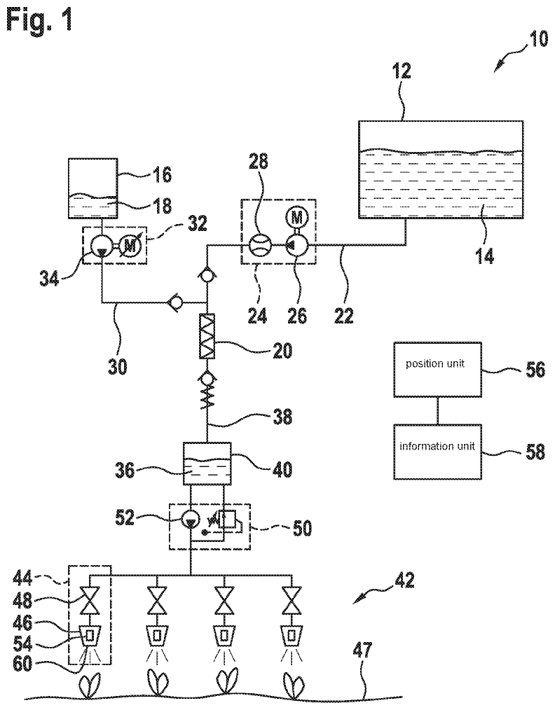

A schematic representation of a spraying device is illustrated in FIG. 1, which is provided in its totality with reference numeral 10.

Spraying device 10 includes a liquid tank 12 including a liquid 14 and an active agent tank 16 including an active agent 18. Liquid 14 is a carrier liquid 14 or water 14.

Spraying device 10 also includes a static mixing unit 20. Static mixing unit 20 is fluidically connected to liquid tank 12 via a liquid line 22. A liquid delivery unit 24 is situated in liquid line 22 to be able to supply liquid 14 to static mixing unit 20 or to conduct it thereto. Liquid delivery unit 24 includes a delivery pump 26 and a volume flow meter 28. Similarly, static mixing unit 20 is also connected to active agent tank 16 via an active agent line 30. An active agent delivery unit 32, in turn, is situated in active agent line 30 to be able to supply active agent 18 to static mixing unit 20 or to conduct it thereto. Active agent delivery unit 32 includes a dosing pump 34.

Accordingly, a mixing of active agent 18 with carrier liquid 14 to form a spray liquid 36 takes place with the aid of static mixing unit 20.

To achieve a greater dosing bandwidth at a high dosing accuracy, a spray liquid tank 40 is situated downstream from static mixing unit 20 in a spray liquid line 38. Spray liquid tank 40 is designed as a buffer tank 40. Spray liquid tank 40 or buffer tank 40 is situated and designed in such a way that spray liquid 36 is filled thereinto from static mixing unit 20 so that it is then conducted from spray liquid tank 40 to a nozzle system 42 including spray nozzle units 44. Each of spray nozzle units 44 includes a spray nozzle 46 for applying spray liquid 36 to an agricultural area 47, and a valve 48 for controlling or regulating the applied spray liquid quantity.

Spraying device 10 furthermore includes a spray liquid delivery unit 50 for setting the spray pressure at spray nozzle units 44, which is designed to supply spray liquid 36 from spray liquid tank 40 to nozzle system 42 or spray nozzle units 44 under pressure or under a defined pressure. Spray liquid delivery unit 50 includes a constant pressure source including a pump 52.

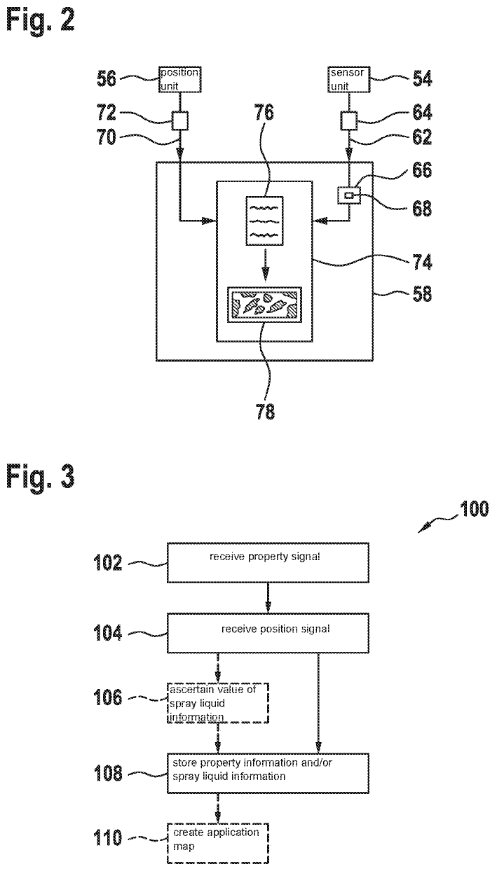

To now be able to detect a spray liquid data set of spray liquid 36 applied to agricultural area 47 with the aid of spray nozzle unit 44, spraying device 10 includes a sensor unit 54 at each of spray nozzles 46 of spray nozzle units 44, a position unit 56 for detecting a piece of position information, and an information unit 58 for storing the spray liquid data set. Sensor units 54 are each designed to detect a piece of property information of spray liquid 36 in a through-flow area 60 of spray nozzle units 44 or spray nozzles 46 of spray nozzle units 44 during the application operation of spray liquid 36, an active agent concentration in spray liquid 36 being ascertainable, using the property information. Position unit 56 is designed to detect a piece of position information of spray liquid 36, the position information representing a geographic position of spray liquid 36 during the application operation of spray liquid 36. The way in which the detection of the spray liquid data set takes place with the aid of information unit 58 is explained below in FIG. 2.

As is apparent in greater detail from FIG. 2, information unit 58 is configured to receive a property signal 62, including a piece of property information 64 of spray liquid 36 detected in corresponding through-flow area 60 of spray nozzle unit 44 with the aid of a sensor unit 54 of spraying device 10. Property information 64 includes here an electrical conductivity of spray liquid 36, a temperature and a volume flow of applied spray liquid 36. Accordingly, sensor unit 54 includes a sensor for detecting the electrical conductivity and a sensor for detecting the temperature as well as a flow sensor or volume flow meter for detecting the applied spray liquid quantity. Information unit 58 is further designed to ascertain a piece of spray liquid information 68 of spray liquid 36 with the aid of a processing unit 66, using property information 64 or the electrical conductivity. Ascertained spray liquid information 68 therefore includes a quantity of applied spray liquid 36 and an active agent concentration in applied spray liquid 36. Information unit 58 is also configured to receive a position signal 70, including a piece of position information 72 of spray liquid 36, from position unit 56, position information 72 representing a geographic position of spray liquid 36 during the application operation of spray liquid 36. Information unit 58 is further configured to store property information 64 and/or ascertained spray liquid information 68 of applied spray liquid 36, together with associated position information 72, with the aid of a memory unit 74 for the purpose of detecting spray liquid data set 76. Finally, information unit 58 is configured to create an application map 78, using detected spray liquid data sets 76, in particular with values of spray liquid information 68. FIG. 3 shows a flowchart of a method 100 for detecting at least one spray liquid data set 76 of a spray liquid 36 applied with the aid of at least one spray nozzle unit 44 of a spraying device 10 to an agricultural area 47. Method 100 includes a step 102 of receiving at least one property signal 62, including a piece of property information 64 of spray liquid 36 detected with the aid of a sensor unit 54 of spraying device 10 in a through-flow area 60 of the at least one spray nozzle unit 44 during an application operation of spray liquid 36. Method 100 also includes a step 104 of receiving at least one position signal 70, including a piece of position information 72 of spray liquid 36, with the aid of a position unit 56, position information 72 representing a geographic position of spray liquid 36 during the application operation of spray liquid 36. Method 100 finally includes a step 108 of storing property information 64 and/or a piece of spray liquid information 68 of applied spray liquid 36 ascertained using property information 64, together with associated position information 72, with the aid of an information unit 58 for the purpose of detecting spray liquid data set 76. Method 100 optionally also includes a step 106 of ascertaining a value of spray liquid information 68, using a value of property information 64, with the aid of information unit 58. Method 100 furthermore optionally includes a step 110 of creating an application map 78, using detected spray liquid data sets 76, in particular including values of spray liquid information 68, with the aid of information unit 58.

If an exemplary embodiment includes an “and/or” linkage between a first feature and a second feature, this is to be read in such a way that the exemplary embodiment has both the first feature and the second feature according to one specific embodiment and either only the first feature or only the second feature according to another specific embodiment.

1-15. (canceled)

16. A method for detecting at least one spray liquid data set of a spray liquid applied using at least one spray nozzle unit of a spraying device to an agricultural area, the method comprising the following steps:
receiving at least one property signal, including a piece of property information of the spray liquid detected using a sensor unit of the spraying device in a through-flow area of the at least one spray nozzle unit during an application operation of the spray liquid;
receiving at least one position signal, including a piece of position information of the spray liquid, using a position unit, the position information representing a geographic position of the spray liquid during the application operation of the spray liquid; and
storing the property information and/or a piece of spray liquid information of the applied spray liquid ascertained using the property information, together with the position information, using an information unit for detecting the spray liquid data set.

17. The method as recited in claim 16, wherein, in the receiving of the property signal step, a large number of property signals are received, each of the large number of property signals including a respective piece of property information of the spray liquid detected using the sensor unit of the spraying device in a through-flow area of each of the spray nozzle units, during the application operation, wherein in the receiving of the position signal step, a large number of position signals are received, each of the large number of position signals including a respective piece of position information of the spray liquid, and in the storing step, the large number of respective pieces of property information and/or ascertained spray liquid information of the spray liquid is stored, in each case together with the respective position information, for detecting a large number of spray liquid data sets.

18. The method as recited in claim 16, further comprising the following step:
ascertaining a value of the spray liquid information, using a value of the property information, with the aid of the information unit.

19. The method as recited in claim 17, further comprising the following step:
creating an application map, using the detected spray liquid data sets, including values of spray liquid information, with the aid of the information unit.

20. The method as recited in claim 16, wherein the property information includes at least one physical property of the spray liquid and/or chemical property of the spray liquid and/or material of the spray liquid and/or substance-based property of the spray liquid.

21. The method as recited in claim 16, wherein the property information includes: (i) a volume flow of the spray liquid, and/or (ii) an active agent concentration in the spray liquid ascertainable using the property information, the property information being at least one of the following group: electrical property, electrical conductivity or permittivity, optical property, in particular absorption property, emission property, fluorescence, sound velocity.

22. The method as recited in claim 16, wherein the ascertained spray liquid information includes a quantity of the applied spray liquid and/or an active agent concentration in the applied spray liquid.

23. The method as recited in claim 16, wherein a value of the property information and/or the spray liquid information is ascertained, using a temperature of the spray liquid and/or a carrier liquid detected with the aid of the sensor unit and/or a further sensor unit.

24. The method as recited in claim 16, wherein the position information includes a a GPS position of the spraying device and/or a position of a particular spray nozzle unit with the aid of which the spray liquid was applied.

25. The method as recited in claim 16, wherein the property information and the position information of the spray liquid are detected for an entire duration of the application operation.

26. The method as recited in claim 16, wherein the property information and/or the position information of the spray liquid, is detected during an entire duration of a treatment operation, in which an entire agricultural area to be treated is treated.

27. An information unit for detecting at least one spray liquid data set of a spray liquid applied using at least one spray nozzle unit of a spraying device to an agricultural area, the information unit configured to:
receive at least one property signal, including a piece of property information of the spray liquid detected using a sensor unit of the spraying device in a through-flow area of the at least one spray nozzle unit during an application operation of the spray liquid;
receive at least one position signal, including a piece of position information of the spray liquid, using a position unit, the position information representing a geographic position of the spray liquid during the application operation of the spray liquid; and
store the property information and/or a piece of spray liquid information of the applied spray liquid ascertained using the property information, together with the position information, using an information unit for detecting the spray liquid data set.

28. A spraying device for applying a spray liquid using at least one spray nozzle unit, for agricultural purposes, the spraying device comprising:
a sensor unit configured to detect a piece of property information of the spray liquid in a through-flow area of the at least one spray nozzle unit during an application operation of the spray liquid;
a position unit configured to detect a piece of position information of the spray liquid, the position information representing a geographic position of the spray liquid during the application operation of the spray liquid; and
(i) an information unit configured to detect a spray liquid data set, and/or (ii) a transmission unit configured to transmit the detected property information, together with the associated position information, and/or a piece of spray liquid information ascertained using the property information, together with the associated position information, to the information unit to detect a spray liquid data set with the aid of the information unit;
wherein the information unit configured to:
receive at least one property signal, including the piece of property information of the spray liquid;
receive at least one position signal, including the piece of position information of the spray liquid; and
store the property information and/or a piece of spray liquid information of the applied spray liquid ascertained using the property information, together with the position information.

29. A non-transitory computer-readable storage medium on which is stored a computer program for detecting at least one spray liquid data set of a spray liquid applied using at least one spray nozzle unit of a spraying device to an agricultural area, the computer program, when executed by a computer, causing the computer to perform the following steps:
receiving at least one property signal, including a piece of property information of the spray liquid detected using a sensor unit of the spraying device in a through-flow area of the at least one spray nozzle unit during an application operation of the spray liquid;
receiving at least one position signal, including a piece of position information of the spray liquid, using a position unit, the position information representing a geographic position of the spray liquid during the application operation of the spray liquid; and
storing the property information and/or a piece of spray liquid information of the applied spray liquid ascertained using the property information, together with the position information, using an information unit for detecting the spray liquid data set.
